(19) United States
(12) Patent Application Publication
(10) Pub. No.: US 2024/0283720 A1
(43) Pub. Date: Aug. 22, 2024

(54) ABNORMAL RECORDING SYSTEM AND THE METHOD FOR NETWORK GATEWAY

(71) Applicant: REALTEK SEMICONDUCTOR CORP., Hsinchu (TW)

(72) Inventors: Peng Tang, Suzhou (CN); Xing Zhang, Suzhou (CN)

(73) Assignee: REALTEK SEMICONDUCTOR CORP., Hsinchu (TW)

(21) Appl. No.: 18/200,120

(22) Filed: May 22, 2023

(30) Foreign Application Priority Data
Feb. 21, 2023 (CN) 202310143587.0

(51) Int. Cl. H04L 41/0604; H04L 41/0686

(52) U.S. Cl. CPC H04L 43/0817; H04L 41/0686

(57) ABSTRACT

An abnormal recording system and the method for network gateway are related to the abnormal recording system including an external server and a gateway. The gateway includes a network interface, a storage unit, and a processing unit. The processing unit connects to the network interface and the storage unit. The network interface connects to the external server. The storage unit stores an abnormal log file. When the processing unit detects an abnormal status, the processing unit generates the abnormal log file according to the abnormal status, and in the booting state, sends the abnormal log file stored in the storage unit to the external server by the network interface.

### CROSS-REFERENCE TO RELATED APPLICATION

This non-provisional application claims priority under 35 U.S.C. § 119(a) to Patent Application No. 202310143587.0 filed in China on Feb. 21, 2023, the entire contents of which are hereby incorporated by reference.

### BACKGROUND

### Technical Field

The present disclosure relates to an electronic device and an abnormal recording system and method thereof, and particularly relates to an abnormal recording system and method for a network gateway.

### Related Art

In order to provide good network connection, many Internet service providers (ISP) will perform corresponding configuration and setting on each domain and relative gateway when establishing an Internet infrastructure. In addition, the Internet service providers will also configure gateways from different manufacturers for domains having different properties.

Because of different specifications and setting environments of the gateway, the Internet service providers may face difficulties in management. Especially after an abnormal status occurs in the gateway, the gateway will usually automatically reboot. After rebooting, all operating statuses of the gateway will be rebooted. Therefore, it is difficult for background workers to acquire relevant information of the gateway when the abnormal status occurs. In addition, due to the difference between the model, software version and setting environment of each gateway, it is more difficult for the background workers to reproduce the abnormal status of the gateway. Particularly, it is difficult for the Internet service providers who deploy a large number of gateways. The Internet service providers may use gateways from different manufacturers to respond to applications in different domains, and the control software (or firmware) versions of the gateways may also be different, so it is more difficult for the background workers to analyze errors.

### SUMMARY

In view of this, in some embodiments, a network gateway includes a network interface, a storage unit and a processing unit. The network interface is in network connection with an external server; the storage unit stores an abnormal log file; the processing unit is connected with the storage unit and the network interface and configured to detect an abnormal status and generate the abnormal log file according to the abnormal status; and in a case that the network gateway is in a booting state, the processing unit is further configured to detect whether the abnormal log file exists in the storage unit or not, and transmit the abnormal log file to the external server through the network interface in a case that the abnormal log file exists in the storage unit. The network gateway can automatically record the current abnormal log file in case of the abnormal status, and thus network Internet service providers can conveniently extract the abnormal log file later.

In some embodiments, the abnormal log file includes an information recording structure; the information recording structure includes device information and abnormal code information; and the device information includes a serial number, manufacturer code information, device model information, media access control information, device firmware information, device software information, abnormal log length consultation or a combination thereof.

In some embodiments, in a case of no abnormal status, the processing unit is configured to generate a system log file according to the normal status and store the system log file in the storage unit; and the abnormal log file is composed of the information recording structure and the information recording structure of the system log file.

In some embodiments, after the abnormal log file is transmitted to the external server, the processing unit can clear the abnormal log file in the storage unit.

In some embodiments, a processing method for recording an abnormal status for a network gateway includes the following steps: detecting whether an abnormal log file exists or not through the network gateway in a case that the network gateway is in a booting state; completing booting and entering a working state through the network gateway in a case that the abnormal log file does not exist; and executing a log recording program through the network gateway in the working state, including: generating and storing the abnormal log file corresponding to the abnormal status through the network gateway in a case that the operating status of the network gateway is an abnormal status; and transmitting the abnormal log file to an external server through the network gateway in a case that the abnormal log file exists.

In some embodiments, the executing a log recording program through the network gateway further includes: generating and storing a system log file corresponding to the normal status through the network gateway in a case that the operating status of the network gateway is a normal status.

In some embodiments, a rebooting operation is executed through the network gateway in a case that the abnormal log file is generated and stored.

In some embodiments, the step of the transmitting the abnormal log file to an external server through the network gateway includes: checking a connection status with the external server through the network gateway; reading and uploading the stored abnormal log file to the external server through the network gateway; confirming whether the abnormal log file is uploaded through the network gateway; and clearing the uploaded abnormal log file through the network gateway after the abnormal log file is uploaded.

In some embodiments, the step of the transmitting the abnormal log file to an external server through the network gateway further includes: retransmitting the abnormal log file by the network gateway in a case that the abnormal log file is failed to upload.

In conclusion, according to the abnormal recording system and method for the network gateway in any embodiment, the network gateway in the working state can record the abnormal log file in the abnormal status so as to store the relevant information of the abnormal status, and the network gateway can automatically transmit the abnormal log file to the external server in the booting state so that an Internet service provider or a background worker can analyze the cause of the abnormal status.

### BRIEF DESCRIPTION OF THE DRAWINGS

FIG. 1 is a schematic diagram of an abnormal recording system for a network gateway according to an embodiment.

FIG. 2 is a schematic diagram of a hardware architecture of a network gateway according to an embodiment.

FIG. 3 is a schematic diagram of an operation flow of an abnormal recording system according to an embodiment.

FIG. 4 is a schematic diagram of a finite-state machine of an abnormal recording system according to an embodiment.

FIG. 5 is a schematic diagram of an architecture of an abnormal log file according to an embodiment.

FIG. 6 is a schematic diagram of an abnormal log partition according to an embodiment.

### DETAILED DESCRIPTION

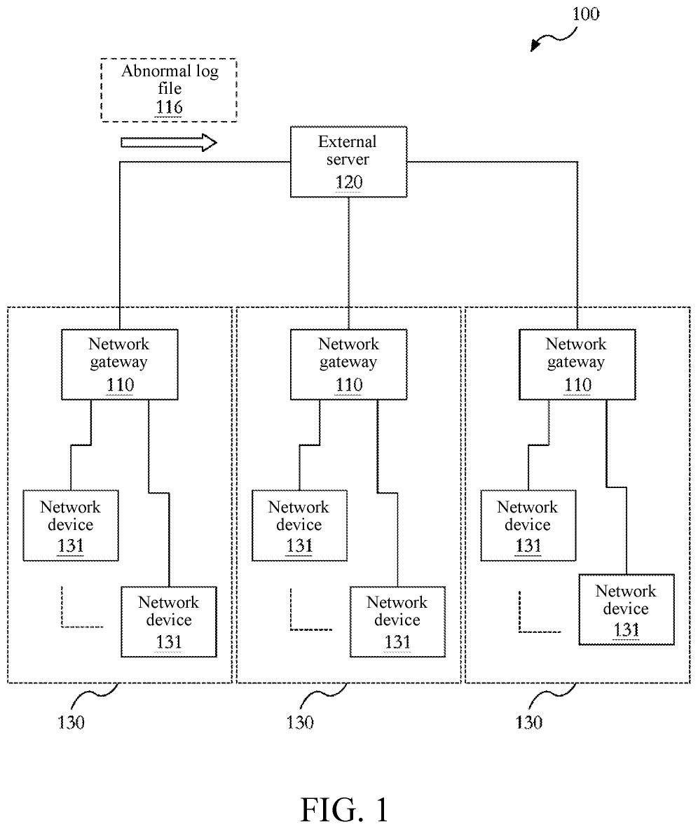

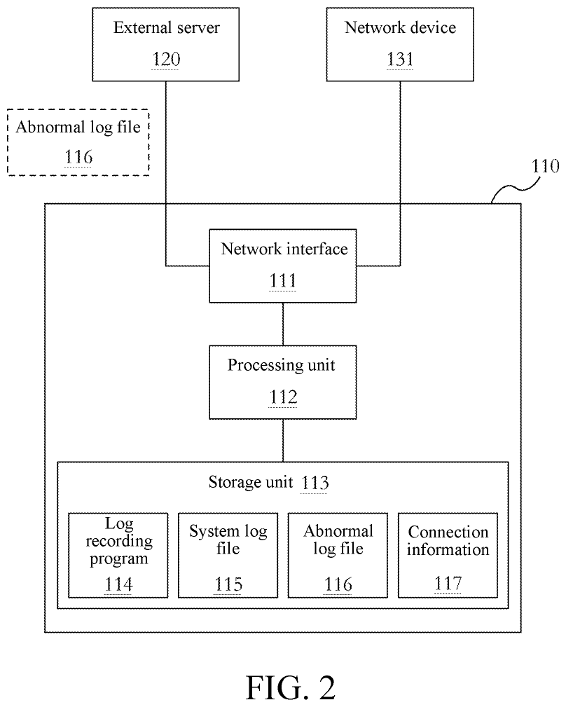

As shown in FIG. 1 and FIG. 2, an abnormal recording system 100 of a network gateway 110 (hereinafter referred to as the abnormal recording system 100) includes the network gateway 110 and an external server 120. Each domain 130 can be provided with at least one network gateway 110. Each network gateway 110 is connected with a plurality of network devices 131 in the domains 130 and connected with the external server 120 outside the domains 130. In FIG. 1, dotted boxes represent the domains 130 to which the network gateways 110 belong. The quantity of the network devices 131 in each domain 130 is not limited to the quantity shown in FIG. 1.

The network gateway 110 includes a network interface 111, a processing unit 112 and a storage unit 113. The processing unit 112 is connected to the network interface 111 and the storage unit 113. The network interface 111 is in network connection with the network devices 131 in the domains 130 and is in network connection with the external server 120 in the domains 130. The network devices 131 can be connected to the network gateway 110 through a wireless network or a wired network or other modes.

In some embodiments, the network interface 111 is a network interface of an Ethernet supporting IEEE802.x, such as an optical fiber network, a multi-stranded network ((Category-5 and 6 series), a power cable or a wireless network. The network devices 131 can be but not limited to a hub, a router, a switch, a bridge or a computing apparatus with network communication. The computing apparatus with network communication can be a personal computer, a notebook computer, a tablet computer or a mobile phone and the like.

The storage unit 113 stores a log recording program 114, a system log file 115 and an abnormal log file 116. In some embodiments, the storage unit 113 can be a flash memory, a programmable read-only memory (PROM), an erasable programmable read-only memory (EPROM), an electrically-erasable programmable read-only memory (EEPROM) or other non-volatile memories.

When the network gateway 110 is operated (namely in a working state), the processing unit 112 is configured to execute the log recording program 114 to record relevant information of the operating status of the network gateway 110 in real time. The processing unit 112 is configured to store the recorded information as the system log file 115 or the abnormal log file 116 according to the operating status of the network gateway 110.

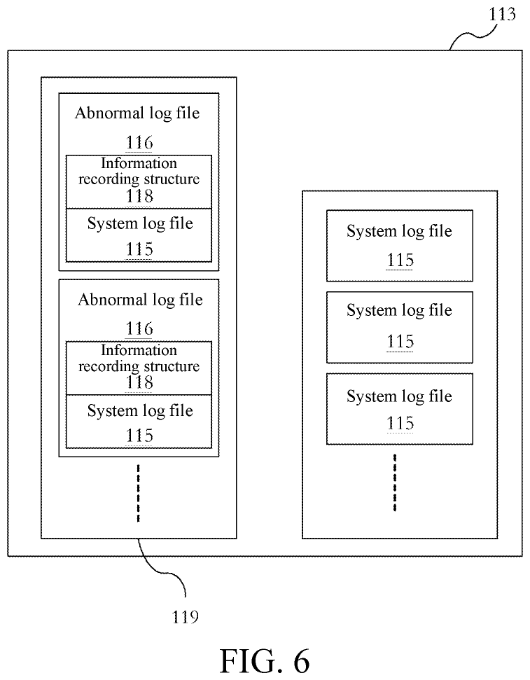

In some embodiments, the storage space of the storage unit 113 can be divided into a plurality of areas, and one of the areas is set as an abnormal log partition 119, as shown in FIG. 6. If the operating status is an abnormal status, the processing unit 112 is configured to generate the abnormal log file 116 for recording relevant information of the abnormal operating status and store the abnormal log file 116 in the abnormal log partition 119. If the processing unit 112 does not detect the abnormal status, the network gateway 110 is in a normal status. If the operating status of the processing unit 112 is the normal status, the processing unit 112 can execute the log recording program 114 to generate the system log file 115 for recording relevant information of the normal operating status. The processing unit 112 is configured to additionally store the system log file 115 in other areas except the abnormal log partition 119 in the storage unit 113. The operation processing of the abnormal log partition 119 and the abnormal log file 116 will be described in detail in the following.

In some embodiments, when the log recording program 114 is executed, the processing unit 112 can record the operation resource status of the network gateway 110 at regular time and can also record the called resource status for each received operation request. For example, if the network gateway 110 receives a “display message” operation request from one network device 131, the operation request corresponds to a “dmesg” instruction of a Linux operating system. Because the “dmesg” instruction request belongs to normal query, the network gateway 110 will query relevant information of current operation resources under the condition that no abnormal status occurs, and the queried relevant information of the operation resources will be stored as the system log file 115. Otherwise, the network gateway 110 will record the relevant information of the current operation resources under the condition that the abnormal status occurs, and the recorded file will be stored as the abnormal log file 116.

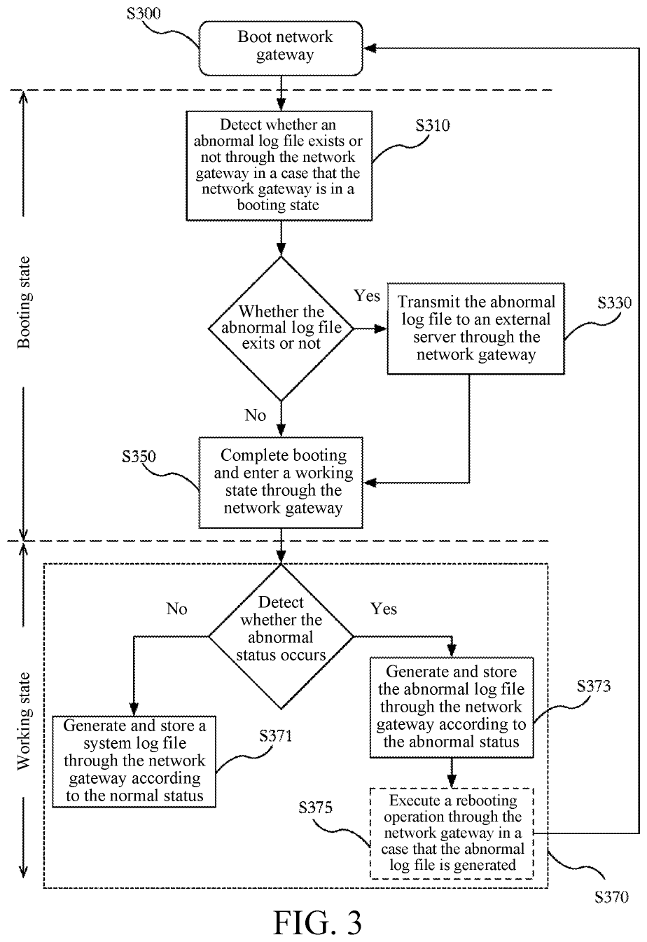

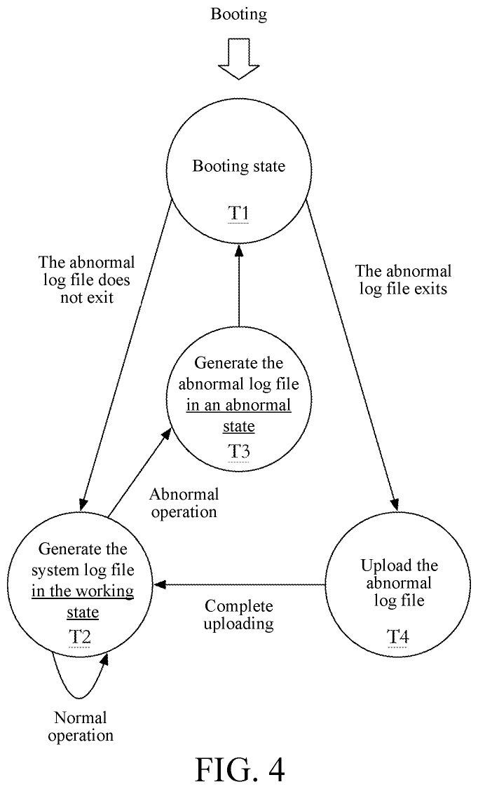

The operating process of the abnormal recording system 100 is further described in combination with FIG. 3 and FIG. 4. FIG. 4 shows a finite-state machine (FSM) of the network gateway 110, representing corresponding processing of the network gateway 110 in various states. As shown in FIG. 1 to FIG. 4, the processing method for the abnormal status of the network gateway 110 includes:
step S310: detect whether the abnormal log file 116 exists or not through the network gateway 110 in the booting state of the network gateway 110;
step S330: transmit the abnormal log file 116 to the external server 120 through the network gateway 110 in a case that the abnormal log file 116 exists;
step S350: complete booting and enter the working state through the network gateway 110 in a case that the abnormal log file 116 does not exist;
step S370: execute the log recording program 114 through the network gateway 110 in the working state of the network gateway 110.

The step S370 includes:
step S371: generate and store the system log file 115 through the network gateway 110 according to the normal status if the operating status of the network gateway 110 is the normal status; and
step S373: generate and store the abnormal log file 116 through the network gateway 110 according to the abnormal status if the operating status of the network gateway 110 is the abnormal status.

In some embodiments, in order to distinguish the operating status of the network gateway 110, the operating status of the network gateway 110 is defined as a booting state and a working state. The booting state generally refers to the operating status of the network gateway 110 in the process of cold boot or warm boot. After the booting state of the network gateway 110 is completed, the network gateway 110 will enter the working state corresponding to a state T1 to a state T2 in FIG. 4.

Besides transmitting network packets, the network gateway 110 in the working state will also receive related instructions from the external server 120 or the network devices 131. The network gateway 110 will feed back corresponding processing results according to the received instructions. A corresponding operating status will be generated for the process that the network gateway 110 processes the received instructions. Generally, when the network gateway 110 is operated normally (namely in the normal status) and receives correct instructions or operations (hereinafter referred to as normal operations), the network gateway 110 will feed back corresponding processing results. If the network gateway 110 receives abnormal instructions or operations (hereinafter referred to as abnormal operations), the abnormal operations may cause abnormal status in operation resources of the network gateway 110, and it is called that the network gateway 110 is in the abnormal status.

After the network gateway 110 is booted (corresponding to step S300), the processing unit 112 of the network gateway 110 will execute booting first to make the network gateway 110 in the booting state, shown as steps S310-S350 in FIG. 3 and the state T1 in FIG. 4. When the network gateway 110 is in the booting state, the processing unit 112 of the network gateway 110 will detect whether the abnormal log file 116 exists in the abnormal log partition 119 of the storage unit 113 (corresponding to step S310). If the abnormal log file 116 does not exist in the storage unit 113, the network gateway 110 will complete booting and be switched from the booting state to the working state (corresponding to step S350 and the state T2 in FIG. 4).

When the network gateway 110 is the working state (as shown in FIG. 4), the network gateway 110 will receive related operations from the network devices 131. As described above, when the network gateway 110 receives the normal operations, the operating status of the network gateway 110 can be called as the normal status. For example, taking a Linux operating system and instructions thereof as an example, if the processing unit 112 of the network gateway 110 receives a “/proc/meminfo” instruction, the processing unit 112 will query the usage amount of a memory according to the “/proc/meminfo” instruction. Since the instructions are only used for querying the usage amount of the memory and do not cause resource exhaustion or a dead abnormal status, the processing unit 112 will treat the query operations as the normal operations. In general, the processing unit 112 is maintained in the state T2 in FIG. 4 during the normal operation until the processing unit 112 detects abnormal operation.

On the contrary, if the processing unit 112 of the network gateway 110 causes resource exhaustion or calling difficulty because of operating the received instructions or operations, the processing unit 112 of the network gateway 110 will treat the operation as the abnormal operation. The abnormal operation includes: pointing an index of the network gateway 110 to an illegal memory section, pointing an empty index to any memory address, using an uninitialized index, and accessing critical resources to cause deadlock or memory exhaustion. Besides the abnormal resource operation, the abnormal operation may also refer to an instruction combination, and then the abnormal resource operation is caused. Taking the Linux operating system and instructions thereof as an example, when the network gateway 110 receives an “echo c>/proc/sysrq-trigger” instruction, the abnormal operation of shutdown of the network gateway 110 may be caused.

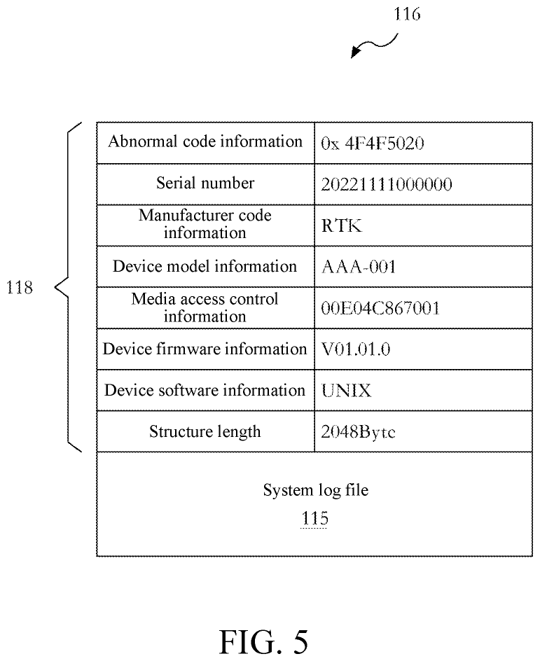

When the network gateway 110 is subjected to normal operation, the processing unit 112 of the network gateway 110 will generate the abnormal log file 116 (corresponding to step S373 and a state T3 in FIG. 4) corresponding to the abnormal operation. The processing unit 112 will generate the abnormal log file 116 which records the relevant information of the abnormal operation. In some embodiments, a single abnormal log file 116 includes the information recording structure 118 and the system log file 115, as shown in FIG. 5. The information recording structure 118 includes device information and abnormal code information. The device information can include a serial number, manufacturer code information, device model information, media access control (MAC), device firmware information, device software information, file identifiers, abnormal log length consultations or any combination thereof. In one embodiment, the abnormal log file 116 is formed by adding a piece of header information (namely the information recording structure 118) to the beginning of the system log file 115. In the information recording structure 118 in FIG. 5, the left field indicates the name of a recording field in the information recording structure 118, and the right field indicates the example content of the corresponding field name, but the example content is only for illustration, it is not limited to this.

The abnormal code information is a representative number of the abnormal status. A background worker can search for the occurrence environment, condition or elimination mode of an abnormal event of the network gateway 110 according to the abnormal code information. The processing unit 112 can generate a serial number according to a timestamp and can also generate a serial number by combining the timestamp with other information. The manufacturer code information is code information of a sales manufacturer of the network gateway 110. The device model information is the model of the network gateway 110. The media access control information is MAC address information of the network gateway 110. The device firmware information is a version of firmware currently operated in the network gateway 110. The device software information is version information of an operating system carried by the network gateway 110.

Specifically, in case of the abnormal status, the processing unit 112 will write relevant information of the network gateway 110 into the corresponding field in the information recording structure 118, and the processing unit 112 will also write the information of the operating process into the system log file 115. Moreover, the processing unit 112 will combine the information recording structure 118 and the system log file 115 into the abnormal log file 116, and store the abnormal log file 116 in the abnormal log partition 119 of the storage unit 113.

In some embodiments, after the abnormal log file 116 is generated (namely after step S373), the processing unit 112 will execute a rebooting operation (corresponding to step S375), so that the network gateway 110 is rebooted to enter the booting state again (namely returning to execute step S300).

In some embodiments, after step S310, if the abnormal log file 116 exists in the storage unit 113, the processing unit 112 will check the connection status with the external server 120. If the connection status is that communication is not established with the external server 120, the processing unit 112 will drive the network interface 111 to in network connection with the external server 120.

In some embodiments, the external server 120 can be a cloud server, and can also be a specified personal computer or a mobile communication apparatus.

In some embodiments, the storage unit 113 can be configured to store connection information 117. The connection information 117 is used for recording the transmission mode of the external server 120, and also recording the network address and login information of the external server 120, such as a user account or password. After being in network connection with the external server 120, the processing unit 112 will log in the external server 120 according to the connection information 117 so as to establish communication connection with the external server 120.

After the connection status is that the communication connection is established with the external server 120, the processing unit 112 of the network gateway 110 will read the abnormal log File 116 in the abnormal log partition 119 of the storage unit 113, and upload the read abnormal log file 116 to the external server 120 (corresponding to step S330 and a state T4 in FIG. 4) through the communication connection. In some embodiments, the processing unit 112 can be configured to select a corresponding transmission mode according to the connection information 117 to upload the abnormal log file 116. In some embodiments, the transmission mode can be but not limited to a file transfer protocol (FTP), a hypertext transfer protocol (HTTP) or a hypertext transfer protocol secure (HTTPS) and the like.

After uploading is started, the network gateway 110 will confirm whether the abnormal log file 116 is uploaded or not. After the abnormal log file 116 is uploaded to the external server 120, the processing unit 112 of the network gateway 110 will clear the uploaded abnormal log file 116 in the storage unit 113 (corresponding to step S330), and then enter the working state from the booting state (corresponding to step S350). For example, after the uploading is completed, the processing unit 112 will clear the abnormal log partition 119 of the storage unit 113, and then enter the working state from the booting state.

In some embodiments, the abnormal log partition 119 is arranged in the storage unit 113, as shown in FIG. 6. The abnormal log partition 119 stores at least one group of abnormal log files 116. Other system log files 115 in the normal status may be stored in other positions of the storage unit 113, which does not influence the storage of the abnormal log files 116, as shown in FIG. 6. When the network gateway 110 is booted, whether the abnormal log file 116 exists in the abnormal log partition 119 or not can be checked. The processing unit 112 will upload the abnormal log file 116 in the abnormal log partition 119 to the external server 120 one by one and clear the transmitted abnormal log file 116 until the abnormal log partition 119 is cleared.

In conclusion, according to the abnormal recording system 100 and method for the network gateway 110 in any embodiment, the network gateway 110 in the working state can record the abnormal log file 116 in the abnormal status so as to store relevant information of the abnormal status, and the network gateway 110 can automatically transmit the abnormal log file 116 to the external server 120 in the booting state so that the network Internet service provider or the background worker can analyze the cause of the abnormal status. Because the network gateway 110 can automatically record and upload the relevant state of the abnormal event of the network gateway 110, the burden of information collection can be effectively reduced for Internet service providers deploying the network gateway 110 in quantity.

What is claimed is:

1. A network gateway, comprising:
a network interface which is in network connection with an external server;
a storage unit for storing an abnormal log file; and
a processing unit, connected with the storage unit and the network interface and configured to detect an abnormal status and generate the abnormal log file according to the abnormal status; and
in a case that the network gateway is in a booting state, the processing unit is further configured to detect whether the abnormal log file exists in the storage unit or not, and transmit the abnormal log file to the external server through the network interface in a case that the abnormal log file exists in the storage unit.

2. The network gateway according to claim 1, wherein the abnormal log file comprises an information recording structure; the information recording structure comprises device information and abnormal code information; and the device information comprises a serial number, manufacturer code information, device model information, media access control information, device firmware information, device software information or a combination thereof.

3. The network gateway according to claim 2, wherein in a case of no abnormal status detected by the processing unit, the processing unit is configured to generate a system log file according to the normal status and store the system log file in the storage unit; and the abnormal log file is composed of the information recording structure and the information recording structure of the system log file.

4. The network gateway according to claim 1, wherein after the abnormal log file is transmitted to the external server, the processing unit can clear the abnormal log file in the storage unit.

5. The network gateway according to claim 1, wherein the processing unit can transmit the abnormal log file to the external server according to a file transfer protocol, a hypertext transfer protocol or a hypertext transfer protocol secure.

6. The network gateway according to claim 1, wherein an abnormal log partition is defined in the storage unit, and the abnormal log file is stored in the abnormal log partition.

7. A processing method for an abnormal status of a network gateway, comprising the following steps:
detecting whether an abnormal log file exists or not through the network gateway in a case that the network gateway is in a booting state;
completing booting and entering a working state through the network gateway in a case that the abnormal log file does not exist; and
executing a log recording program through the network gateway in the working state, comprising:
generating and storing the abnormal log file corresponding to the abnormal status through the network gateway in a case that the operating status of the network gateway is an abnormal status; and
transmitting the abnormal log file to an external server through the network gateway in a case that the abnormal log file exists.

8. The processing method for the abnormal status of the network gateway according to claim 7, wherein the executing a log recording program through the network gateway further comprises:
generating and storing a system log file corresponding to the normal status through the network gateway in a case that the operating status of the network gateway is a normal status.

9. The processing method for the abnormal status of the network gateway according to claim 7, further comprising: generating and storing a system log file corresponding to the abnormal status through the network gateway in a case that the operating status of the network gateway is the abnormal status; and
executing a rebooting operation through the network gateway in a case that the abnormal log file is generated and stored.

10. The processing method for the abnormal status of the network gateway according to claim 7, wherein the step of the transmitting the abnormal log file to an external server through the network gateway comprises:
checking a connection status with the external server through the network gateway;
reading and uploading the stored abnormal log file to the external server through the network gateway;
confirming whether the abnormal log file is uploaded through the network gateway; and
clearing the uploaded abnormal log file through the network gateway after the abnormal log file is uploaded.

11. The processing method for the abnormal status of the network gateway according to claim 10, wherein the step of the transmitting the abnormal log file to an external server through the network gateway further comprises: retransmitting the abnormal log file by the network gateway in a case that the abnormal log file is failed to upload.
